(19) United States
(12) Patent Application Publication
(10) Pub. No.: US 2007/0236049 A1
(43) Pub. Date: Oct. 11, 2007

(54) MODULAR ASSEMBLY FOR A VEHICLE

(75) Inventors: David L. Chapman, Lake Orion, MI (US); Luis Lorenzo, Plymouth, MI (US); Keith Kauffman, Ann Arbor, MI (US); Ashish Vijay Kotnis, Rochester Hills, MI (US)

Correspondence Address: DOBRUSIN & THENNISCH PC, 29 W. LAWRENCE STREET, STE. 210, PONTIAC, MI, 48342, US

(73) Assignee: Dow Global Technologies Inc.

(21) Appl. No.: 11/692,285

(22) Filed: Mar. 28, 2007

Related U.S. Application Data
(60) Provisional application No. 60/788,131, filed on Mar. 31, 2006.

(51) Int. Cl. B60J 7/00

(52) U.S. Cl. 296/193.08

(57) ABSTRACT

There is disclosed a modular assembly and method of forming the assembly. The assembly is particularly suitable as at least part of a rear end of a transportation or automotive vehicle. The assembly preferably includes one or more plastic structure adhesively secured to one or more metal structures.

### CLAIM OF BENEFIT OF FILING DATE

The present application claims the benefit of the filing date of U.S. Provisional Application Ser. No. 60/788,131, filed Mar. 31, 2006, hereby incorporated by reference.

### TECHNICAL FIELD

The present invention relates to a modular assembly for a vehicle and a method of forming the modular assembly, applying the modular assembly or both. More particularly, the present invention relates to a rear end modular assembly for an automotive vehicle and a method of forming the assembly, attaching the assembly to a rear portion of the automotive vehicle or both.

### BACKGROUND OF INVENTION

Generally, the transportation industry has sought to form innovative modular assemblies for transportation vehicles that address issues such as labor reduction, cost savings, structural integrity, simplicity in the vehicle assembly process, combinations thereof or the like. As examples, U.S. Patent Publication Nos. 2003/0001410; 2004/0094976; and 2005/0035609, all of which are expressly incorporated herein by reference for all purposes, disclose modular assemblies (e.g., a front end modular assembly) suitable for attachment to an automotive vehicle.

In continuing such innovation, the present invention provides a modular assembly, and more particularly a rear end modular assembly for a vehicle that addresses one of the aformentioned issues or other issues as will become apparent from the detailed description of the invention.

### SUMMARY OF THE INVENTION

Accordingly, there is disclosued a rear module for an automotive vehicle and a method of forming the module and applying the module to an automotive vehicle. The module typically includes a first cross-vehicle structure, a second cross-vehicle structure and can also include a third cross-vehicle structure. The first cross-vehicle structure is preferably a panel formed substantially entirely of plastic material. The second cross-vehicle structure is preferably formed substantially entirely of a metal material and the second cross vehicle structure is typically attached to the first cross vehicle structure with adhesive and preferably less than 10 welds. The third cross-vehicle structure, when included, is typically attached to the first vehicle structure with adhesive and less than 10 welds. Moreover, according to a preferred aspect of the invention, the third structure can be configured to extend along an upper edge of the first structure.

The rear module is configured for attachment to a rear portion of the vehicle such that the rear module, including the first structure, the second structure, the third structure or any combination thereof, extends laterally across the rear portion of the vehicle and preferably substantially entirely across the rear portion of the vehicle. In one preferred aspect of the invention, the first structure, second structure or both are a substantial portion of the vehicle that defines the trunk space of the vehicle. The second cross-vehicle structure is preferably located inside the first vehicle structure relative to the vehicle but can be located outside unless otherwise specifically stated. It is also contemplated that the second structure or the third structure or both are attached to the first structure without any welds. According to another additional or alternative preferred aspect of the present invention, the second cross vehicle structure can be adhered to the first cross vehicle structure such that a cavity of the first structure, a cavity of the second structure or both is formed into a substantially enclosed tunnel between the first and second structures. According to still another additional or alternative preferred aspect of the present invention, the second structure can include a plurality of second openings that align with a plurality of first openings of the first structure and are cooperatively configure for receiving fasteners that fasten a bumper beam to the vehicle and particularly to the vehicle frame rails. It is contemplated that the the third structure can be separate from the second structure or the third structure can be attached to the second structure.

Additional aspects and advantage of the module and method of the present invention will become apparent upon reading the detailed description of the invention.

### DESCRIPTION OF THE DRAWINGS

FIG. 1 is an exploded perspective view of an exemplary rear end modular assembly according to an aspect of the present invention.

FIG. 2 is an assembled perspective view of the exemplary rear end modular assembly of FIG. 1.

FIG. 3 is an assembled cut away view of the exemplary rear end modular assembly of FIGS. 1 and 2 assembled to a vehicle.

FIG. 4 is an exploded view of an additional or alternative exemplary rear end modular assembly according to an aspect of the present invention.

FIG. 5 is an exploded view of an additional or alternative exemplary rear end modular assembly according to an aspect of the present invention.

### DETAILED DESCRIPTION OF THE PREFERRED EMBODIMENT

The present invention is predicated upon the provision of a modular assembly suitable for attachment to a transportation vehicle. The modular assembly may be attached to various portions of a vehicle, however, it is particularly suited for attachment to a rear portion of an automotive vehicle such as a sedan, a convertible, a mini-van, a sport utility vehicle (SUV) or the like such that the assembly is part of a rear end of the automotive vehicle. The modular assembly typically includes at least two, but can include any combination, of the following:
1) a first structure that is preferably configured to extend cross-vehicle and is also typically formed substantially entirely of a polymeric material;
2) a second structure that is preferably configured to extend cross-vehicle, is preferably co-extensive with the first structure and is typically formed substantially entirely of a metal material;
3) a third structure that is preferably configured to extend cross-vehicle, is preferably co-extensive with the first structure, the second structure or both and is also typically formed substantially entire of a metal material; and
4) one or more lighting assemblies, which are typically located within or adjacent one or more cavities at distal ends of the the first structure.

It is additionally contemplated that other components such as a bracket (e.g., crush brackets), a bumper beam, fasteners, locators, combinations thereof or the like may be included in the assembly.

The present invention is also predicated upon a methodology of forming the modular assembly, attaching the modular assembly to a vehicle or both. The methodology typically includes at least two, but can include any combination, of the following steps:
1) attaching the first structure to the second structure with an adhesive and preferably less than 20 welds;
2) attaching the third structure to the first structure with an adhesive and preferably less than 20 welds;
3) attaching the modular assembly to an automotive vehicle with an adhesive, mechanical fasteners or both and preferably less than 20 welds.

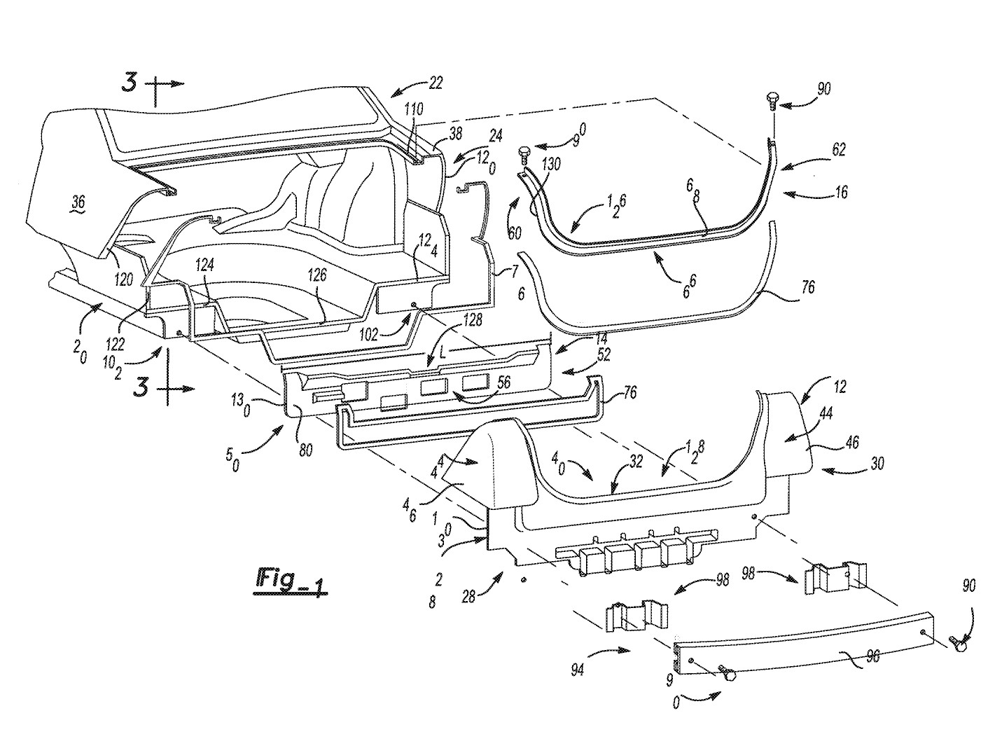

Referring to FIGS. 1-3, there is illustrated an exemplary rear end modular assembly or module 10 in accordance with the present invention. The illustrated assembly 10 includes a first structure 12, a second structure 14 and a third structure 16.

The first structure 12 is illustrated as a panel configured to extend cross-vehicle substantially from one side 20 of the vehicle 22 to the other side 24 of the vehicle 22. The first structure 12 is shown to include a first distal portion 28 opposite a second distal portion 30 and an intermediate portion 32 interconnecting the first and second distal portions. Upon assembly of the module 10 to the vehicle, the the first and second distal portions 28, 30 are configured to be adjacent first and second rear quarter panels 36, 38 and the first and second distal portions 28, 30 are configured to extend upwardly relative to the intermediate portion 32 upon assembly of the module to the vehicle. The first vehicle structure 12 is also shown as defining a cavity 40 that extends substantially entirely cross-vehicle and along the intermediate portion 32 of the first structure 12.

In the particular embodiment illustrated, the first and second distal portions each define a cavity 44 for receiving at least a portion of a rear vehicle lamp assembly 46. As shown, there is a lamp assembly 46 to be located in each of the cavities 44. Each lamp assembly 46 will typically include a light emitter (e.g., a light bulb or LED) and a mounting for supporting and/or receiving the light emitter and/or electrical connections for electrically connecting the assembly to wires or busses of the vehicle. As used herein, however, it should be understood that the lamp assembly may include only one of the components of the discussed assemblies or may include one or plural additional or alternative components used in lighting.

Generally, it is contemplated that the first structure may be formed of a variety of materials such a metal material (e.g., metal alloys, metal containing materials, pure metals or the like), polymeric materials (e.g., plastics), other materials, combinations thereof or the like. In one preferred embodiment, the first structure of the present invention is made partially or substantially entirely (e.g., at least 80%, 90%, 95% or more by weight) from polymeric and/or plastic material, and more preferably thermoplastic material. In a particularly preferred embodiment, the first structure is made from a high strength thermoplastic resin selected from styrenics, polyamides, polyolefins, polycarbonates, polyesters or mixtures thereof. Still more preferably the resin is selected from the group consisting of acrylonitrile butadiene styrene, polycarbonate/acrylonitrile/butadiene styrene, polycarbonate, polyphenylene oxide/polystyrene, polybutylene terephthalate, polyphenylene oxide, polyphenylene ether, syndiotactic polystyrene, ethylene alpha olefin, polybutylene terephthalate/polycarbonate, polyamide (e.g., nylon), polyesters, polypropylene, polyethylene, polyethylene terephthalates, mixtures, alloys and blends thereof.

It is contemplated that the plastic material for making the first structure may be provided as neat resins, blends or otherwise. Moreover, the polymeric materials may incorporate natural, mineral, fibrous or other fillers of various shapes and sizes for providing reinforcing, stiffening or other characteristics to the frames or structures.

In other preferred embodiments, the plastics material for one or more of the first structure may comprise a homopolymer, for example a polyolefin, a polyamide, a polyphenylene oxide and polystyrene, or a copolymer, for example a polyalkylene terephthalate.

In other embodiments, the plastic material may be a thermosetting plastic resin. For example, a polyurethane system may be employed for forming the first structure.

The plastics material may contain fibre, for example short glass fibre, long glass fibre, short natural fibre or long natural fibre. Other preferred plastic materials may include talc, minerals or the like. Advantageously, it has been found that relatively long glass fibers add a relatively high degree of strength. Thus, in preferred embodiments, a polymeric material such as ABS, PC\ABS, polypropylene or another suitable plastic is filled with glass fibers having an average length of approximately greater than 2 mm, more preferably greater than about 4mm even more preferably greater than about 6 mm and most preferably between about 8 mm and 20 mm.

It is possible to form the first structure using art-disclosed techniques for the fabrication of the material selected. Thus, for example, the first structure may be formed, molded, machined or otherwise configured to the desired shape. Metal structures may be roll formed, cast, stamped or the like.

Where the first structure is plastic, it is possible to use any suitable plastic fabrication technique including, without limitation, injection molding (including but not limited to external or internal gas injection molding), blow molding, compression molding, rotational molding, thermoforming, extruding, vacuum forming, foaming-in-place, or otherwise. Accordingly, as can be appreciated, in one embodiment, hybrid structures can be fabricated, thereby taking advantage of the benefits of different respective materials and different respective fabrication techniques, and also advantageously permitting for the ability to design additional features. It is also contemplated that the first structure may be two shot molded to include insulator pads for accommodating lamp assemblies (e.g., tail lights).

For thermosetting materials, any suitable forming techniques may be used. For example, reaction injection molding (RIM) techniques may be employed. Preferred RIM techniques might include structural reaction injection molding (SRIM), reinforced reaction injection molded (RRIM), low density reaction injection molded (LD-RIM) (which may be reinforced or structural) or the like. Alternative techniques such as resin transfer molding (RTM) may also be employed.

Fillers appropriate for RIM (e.g., RRIM or LD-RRIM) materials include, without limitation, mineral quasi-isotropic particles such as mica or wollastonite having various aspect ratios. Structures suitable for RIM (e.g., SRIM or LD-RIM) materials include, without limitation, spray-up fiber preforms, oriented fiber preforms, random fiber preforms, or single or multiple fiber reinforcing layers preplaced in the manufacturing tools prior to injection of the resin.

The second vehicle structure 14, like the first structure 12, is illustrated as a panel configured to extend cross-vehicle substantially from one side 20 of the vehicle 22 to the other side 24 of the vehicle 22. In the embodiment depicted, the second cross-vehicle structure 14 has a length (L) and the structure 14 as well as its length (L) extend from a first distal end 50 to a second distal end 52 of the structure 14. As shown, the second distal end 52 is opposite the first distal end 50. The second cross vehicle structure 14 is also illustrated as defining a cavity 56 that extends along substantially the entire length (L) of the second structure 14. Of course, when the second structure 14 defines such a cavity 56, it can extend only partially or intermittently along the second structure 14 if desired.

The third structure 16 is illustrated as an elongated member that is also configured to extend cross-vehicle substantially from one side 20 of the vehicle 22 to the other side 24 of the vehicle 22 upon assembly of the module 10 to the vehicle 22. As shown, the third cross vehicle structure 16 extends from a first distal end 60 to a second distal end 62 thereof. The third structure 16 is also shown as defining a first cavity 66 and/or a second cavity 68 that extends partially or substantially entirely along the third structure 16 from its first distal end 60 to its second distal end 62. Upon assembly to the vehicle one of the cavities can serve as a water or rain channel.

Generally, it is contemplated that the second and third structures may be formed of a variety of materials such a metal material (e.g., metal alloys, metal containing materials, pure metals or the like), polymeric materials (e.g., plastics), other materials, combinations thereof or the like. As such, it is contemplated that the second and third structure may be formed of any of the materials and using any of the forming techniques discussed herein.

Typically, the second structure, the third structure or both are formed of metal materials. Examples of suitable metals that can be included in the metal materials include steel, titanium, iron, magnesium, aluminum, combinations thereof or the like. In one preferred embodiment, the metal material that forms the second structure, the third structure or both are at least 50% by weight metal, more typically at least 70% by weight metal and even more typically at least 90% by weight metal. Preferred forming techniques, which may be employed for shaping the second and third structures include, without limitation, casting, stamping, roll forming, hydroforming or the like. For such components, it may be desirablet o apply corrosion inhibitor (e.g., e-coat) thereto depending upon when the module is assembled to the vehicle.

Generally, it is contemplated that the first structure may be directly or indirectly attached to the first structure, the second structure or both and the second structure may be directly or indirectly attached to the third structure. Moreover, various attachments may be used for securing the structures together. Examples of such attachments include, without limitation, mechanical fasteners (e.g., clips, screws, rivets, nuts and bolts, interlocking devices, combinations thereof or the like), adhesives, welds (e.g., from vibration welding, spot welding, RF welding or the like), other attachments, combinations thereof or the like.

In one embodiment, the first structure is attached or secured to the second structure, third structure or both with adhesive and the first structure is attached to the second structure, third structure or both with few weld. Preferably, the first structure is attached or secured to the the second structure, the third structure or both with less than 20 welds, more typically less than 10 welds, even more typically less than 5 welds and can be attached or secured without any welds.

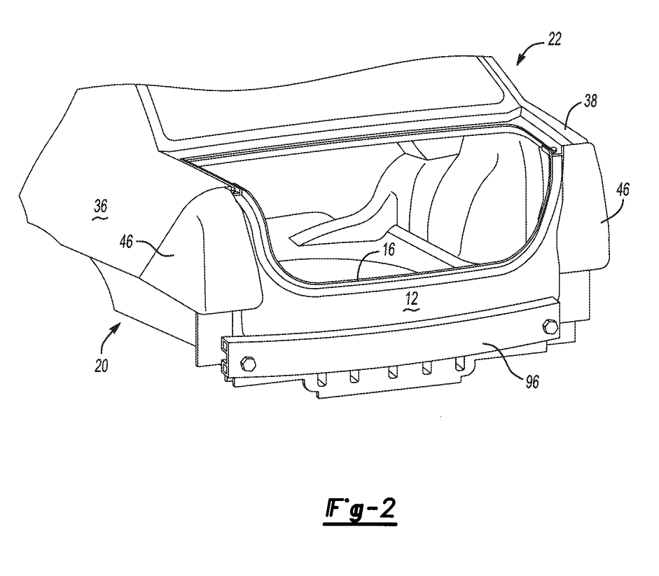

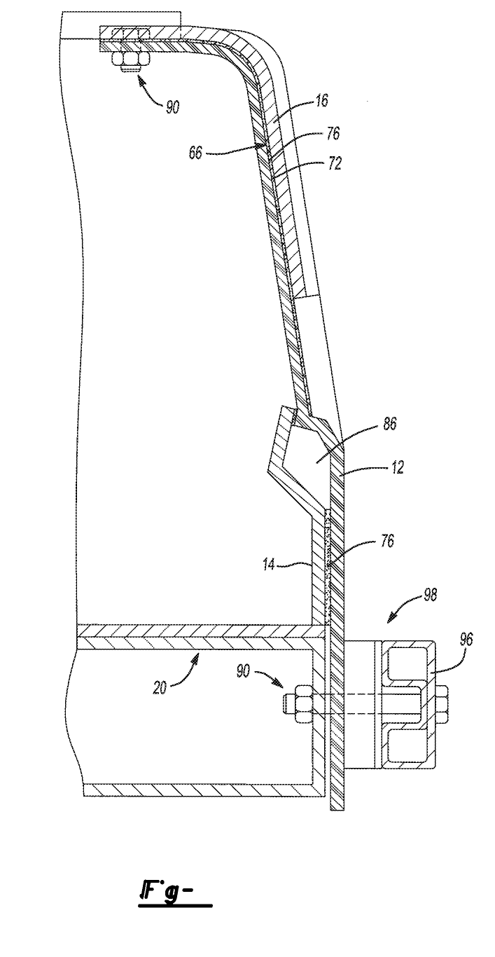

In FIGS. 2-3, the first structure 12 is directly secured to the second structure 14 and the third structure 16 with adhesive 76. As shown, the second cross vehicle structure 14 has a peripheral edge surface 80 that is adhered to a surface 82 of the first cross vehicle structure 12. Upon attachment of structures 12, 14 the cavity 40 of the first structure 12 and the cavity 56 of the second structure 14 cooperatively form a substantially enclosed tunnel 86 between the first and second structures 12, 14. Of course, when such a tunnel 86 is formed, it is possible that only one of the structures 12, 14 may define a cavity and the other of the structure could provide a wall that encloses that cavity.

The embodiment of FIGS. 1-3 also shows the first structure 12 being directly secured to the third structure 16 with adhesive 76. The third structure 16 is configured to extend along an upper edge of the first structure 12. Upon attachment of the structures 12,16 the third structure 16 and first structure 12 enclose the cavity 66 of the third structure 66 thereby forming the tunnel 72. Of course, when such a tunnel is formed, it is possible that the first structure 12, the third structure 16 or both may include cavities for forming the tunnel.

It is additionally contemplated that a fastening or latch mechanism may be integrated into the module. In one preferred embodiment, a latch for the vehicle trunk is attached to the first structure, the second structure or both and may be partially located with the tunnel 86 formed by those structures.

When used, any suitable adhesive may be employed in the present invention. Preferably, the adhesive is compatible with (i.e., capable of adhering to) the material of the surfaces of the structures. If, however, the adhesive is slightly incompatible with one of these materials, it may be desirable to treat the surface[s] formed of the incompatible material. Exemplary treatments include the application of primer, exposure to plasma, combinations thereof or the like. The adhesive can be a urethane based adhesive, and more preferably a urethane adhesive. Alternatively, the adhesive may include a functional component selected from acrylonitrile butadiene styrene (ABS), polycarbonate (PC), or a mixture thereof (e.g. PC-ABS). The adhesive can additionally or alternatively be a silane adhesive, a silicone adhesive or a mixture thereof. An acrylic adhesive may be additionally or alternatively be employed. The adhesive may also be epoxy based. It may include polyolefinics, styrenics, acrylics or mixtures thereof. In one embodiment, a preferred adhesive includes alkyl borane. Examples of suitable adhesives are disclosed in commonly owned U.S. Pat. No. 09/466,321 (filed Dec. 17, 1999) and patent publication numbers 20020058764 and 20030001410 expressly incorporated herein by reference for all purposes. Any such adhesive may include suitable performance modifiers including art disclosed tackifiers, elastomers, impact modifiers, or the like.

In one embodiment, a two part, organoborane/amine complex adhesive or other adhesive is employed for adhesively securing the structures together. Advantageously, such an adhesive can adhere to low surface energy surfaces or substrates. As such, the adhesive is preferably capable of bonding to corresponding surfaces having a surface energy of less than 65 mJ/m², more typically less than 45 mJ/m². As used herein, this surface energy applies to measurements of smooth surfaces. It should be understood that roughening or otherwise treating the surfaces can lower the surface energy. Moreover, it should be understood that these surface energies do not limit the surfaces or surface energies of the surfaces to which the adhesives are applied unless otherwise specifically stated.

For any of the adhesive attachments to surfaces of components of the present invention, but particularly where lower surface energy surfaces are present, it is contemplated that such attachments may be directly to those surface without a primer being applied to those surfaces beforehand. This is particularly the case where certain adhesives disclosed herein (e.g., the organoborane amine complex adhesive) is employed. Of course, however, primer can be used if necessary or desired when other adhesives are desired or to further assist any of the other adhesive disclosed herein such as the organoborane amine complex adhesive.

Adhesives, polymerizable compositions and method of use disclosed in International Patent Application No. PCT/US00/33806, incorporated herein by reference, are especially preferred for use in the present invention to bond the structures.

Once the adhesive has been applied, it will typically require some amount of time to cure (e.g., part cure, full cure, cure on demand, air cure, heat cure, moisture cure, chemical cure, radiation cure, or the like). Preferably, the adhesive cures at about room temperature (e.g., between about 20° C. to about 30° C.), but may be exposed to elevated or lowered temperatures for accelerating or slowing cure times. During cure, it may be desirable to employ a device (e.g., push-pins, clamps, clips or the like) for holding the frames and/or structures together. Such fasteners may be removable or may be intended to assist in securing the structures together during use of the module.

Additionally or alternatively, the surfaces or other portions of the structures that are adhered together may be formed (e.g., molded) to have interfitting and/or interlocking features for attaching the structures together during adhesive cure or any other time. For example, a corresponding surface of one structure may include one or more openings (e.g., cavities) for receiving one or more protrusions of a corresponding surface of another structure.

Preferably, the module or modular assembly, including the first structure, the second structure, the third structure, the light emitter assemblies, other components discussed herein, combinations thereof or the like, is assembled as a unit to a portion (e.g., the rear portion) of the vehicle. Generally, any of the attachments discussed may be used to attach the module to the vehicle. Examples include, without limitation, mechanical fasteners (e.g., clips, screws, rivets, nuts and bolts, interlocking devices, combinations thereof or the like), adhesives, welds (e.g., from vibration welding, spot welding, RF welding or the like). In one preferred embodiment, the rear end module is attached to the rear portion of the vehicle with a combination of mechanical fasteners and few if any welds. In such an embodiment, the module is attached or secured to a portion (e.g., a rear portion) of the vehicle with adhesive, one or multiple mechanical fasteners (e.g., nut and bolt assemblies) and less than 20 welds, more typically less than 10 welds, even more typically less than 5 welds and can be attached or secured without any welds. In the embodiment, adhesive securing may take place before or after mechanical fastening with fastener or may take place intermittently.

Adhesive is generally applied by contacting one or more surfaces of the vehicle and one or more surfaces of the module with the adhesive. In turn, the adhesive cures and/or adheres to the surfaces attaching the module to the vehicle. Adhesive may be contacted with one or more surfaces of the first structure, the second structure or the third structure or any combination thereof and may be contacted with one or more surfaces of the inner or outer body panels, the vehicle floor (e.g., floor pan), the wheel well, trunk floor, vehicle rails, members connected to these vehicle components, any combination thereof or the like for attaching or at least assisting in attaching the module to the vehicle. Moreover, various types of mechanical fasteners such as those discussed herein or others may be employed to attach the the first structure, the second structure or the third structure or any combination thereof to vehicle components such as the inner or outer body panels, the vehicle floor (e.g., floor pan), the wheel well, vehicle rails, trunk floor, members connected to these vehicle components, any combination thereof or the like. Of course the adhesive used may be any of those discussed herein or others.

In the exemplary embodiment illustrated in FIGS. 1-3, the modular assembly 10 is attached to the rear portion of the vehicle 22 with mechanical fasteners 40 shown nut and bolt assemblies and adhesive 76. In the embodiment shown, the first structure 12, the second structure 14 or both can include openings (e.g., through-holes) for receipt of the mechanical fasteners that attach the module 10 to the rear portion of the vehicle. Such mechanical fasteners 90 can also attach a bumper assembly 94, shown as a bumper beam 96 and crush brackets 98, to the rear portion of the vehicle. While the bumper assembly is shown as a bumper beam with crush brackets, it is contemplated that several different bumper assemblies may be employed such as metal(e.g., steel)/plastic composite bumpers or bumper beams or other bumber assemblies.

As an example, the bolts from the nut and bolt assemblies can extend through openings in the bumper beam 96, openings in the crush brackets 98, openings in the first structure 12, openings in the second structure 14, openings in the rear portion of the vehicle or any combination thereof and can be fastened, via the nut, such that those components are attached to each other. In a preferred embodiment, the fasteners 90 are attached to the vehicle rails 102 and can be attached directly to the vehicle frame rails 102 or attached to one or more stuctures (e.g., end plates) that are directly or indirectly attached to the vehicle rails 102 thereby closely attaching the module and particularly the second structure 14 of the module 10 to the rails 102.

Mechanical fasteners 90 shown as nut and bolt assemblies are also used to attach the third structure 16 to the rear portion of the vehicle. As shown, the mechanical fasteners 90 attach the third structure 16 to a drainage channel 110 extending about the opening of the trunk of the vehicle.

It is also contemplated that the bumper beam assembly coupd include additional components. Examples include, without limitation, absorbers and a number fascia.

The adhesive typically contacts surfaces associated with components of the rear end portion of the vehicle and also contacts surfaces of the module (i.e., the structures 12, 14, 16) where portions of components of the module overlap the components of the vehicle. Suitable surfaces of the vehicle for adhesive application or contacting include, without limitation, edge surfaces 120 of body panels (e.g., rear quarter panels), edge surfaces 122 of wheel wells, edge surfaces 124 of trunk floor, edge surfaces 126 of spare wheel well, surfaces of structures connected to the aforementioned components, any combination thereof or the like. Suitable surfaces of the module include, without limitation, body surfaces 128 or peripheral surfaces 130 of the first, second and third structures 12, 14,16.

Upon assembly to the vehicle, the module and particulary the first structure, the second structure or both may assist in defining the trunk space of the vehicle.

It has been found that adhesive securing of the structures and or the module as discussed herein can provide advantages for the overall module or assembly. As one example, it can provide for sealing and securing such that an additional sealer may not be necessary whereas techniques such as welding or otherwise can require such a sealer. As another example, it can minimize equipment required for assembly of the module and/or assembly to a vehicle. Of course, the skilled artisan will recognize other advantages provided by the present invention and will also recognize that no particular advantage is required as part of the invention, unless otherwise stated.

It is also contemplated that the rear end of the vehicle, the structures of the module or the other components may include locators for assisting assembly of the module to the vehicle. For example, the structures of the module cousl include one or more members (e.g., protrusions) configured to estend in openings (e.g., cavities) in the rear end of the vehicle or vice versa.

As suggested, various of the components of the module can be assembled together prior to assembly of the module to the vehicle. In one preferred embodiment, the first structure 12, the second structure 14, the third structure 16 and, optionally, the bumper structure 96 and/or the lamp assemblies 44 are assembled together as a singular module 10 to the vehicle. In another preferred embodiment, however, the second structure 14 is already attached (e.g., adhesively secure or welded) to or integral with the rear end of the vehicle prior to assembly of the module 10 to the vehicle. In such an embodiment, the first structure 12, the third structure 16 and, optionally, the bumper structure 96 and/or the lamp assemblies 44 are assembled together as a singular module 10 to the vehicle.

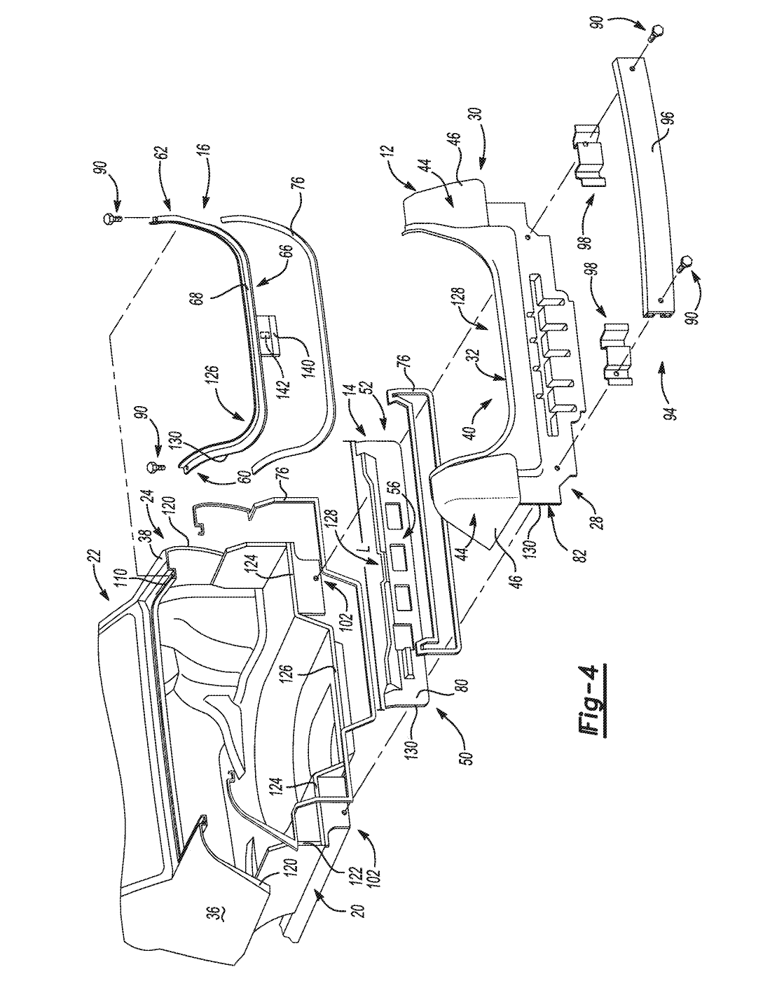

In any of the embodiments discussed herein, and with reference to FIG. 4, a connector piece or panel 140 can be included as part of the module 10 and/or the first, second and/or third structures 12, 14, 16. Such a connector panel 140 can be formed of any of the polymeric or metals discussed herein. If the second panel structure 14 is part of the module 10, the connector panel 140 could be secured to (e.g., integrally formed with, adhesively or mechanically secured, welded) the first structure 12, the second strucuture 14, the third strucuture 16 or any combination thereof prior to assembly of the module 10 to the vehicle. If the second panel structure 14 is already part of the vehicle prior to assembly of the module, the first structure 12, the second structure 14 or both can be secured to (e.g., integrally formed with, adhesively or mechanically secured, welded) to the connector member 140 prior to assembly of the module 10 to the vehicle and then upon assembly of the module 10 to the vehicle, the connector piece 140 can be secured (e.g., integrally formed with, adhesively or mechanically secured, welded) to the second structure 14. Advantageously, the connector piece 140 can be employed to support a latch mechanism 142 for detachably securing to a trunk lid. It is contemplated that any of the attachments discussed herein and others may be employed for securing of these components together.

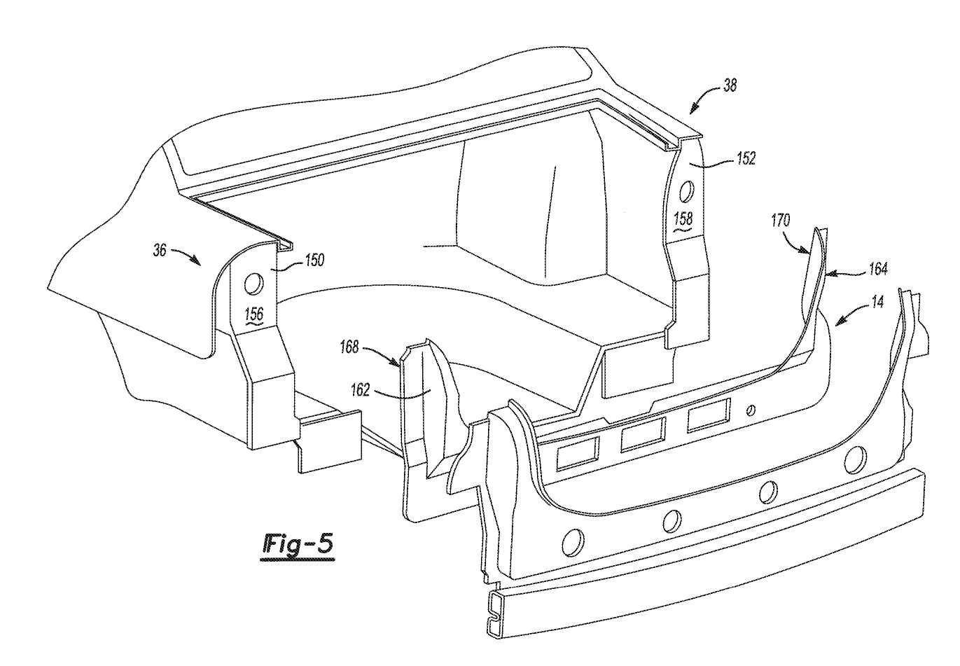

In FIG. 5, there is illustrated an additional or alternative embodiment of the rear end module of the present invention that can be substantially similar or identical to the embodiments of FIGS. 1-4 with a few notable exceptions or additions. In particular, a first connection panel 150 and a second connection panel 152 are located adjacent the rearward sides and/or rear quarter panels 36, 38 of the vehicle. In the particular embodiment illustrated, these panels 150, 152 are attached to (e.g., welded or integrally formed with) the rear quarter panels 36, 38, the vehicle rear wheelhouses or both. As can be seen, the connection panels 150 and 152 are disposed substantially transverse relative to the fore/aft direction of the vehicle to provide attachment surfaces 156, 158 facing rearwardly and outwardly from the vehicle. While it is contemplated that these panels 150, 152 may be formed of any of the materials discussed herein, it is generally preferred that they be made of metal such as steel.

As can also be seen, end portions 162, 164 of the second structure 14 have been added. These portions 162, 164 are shown to extend upwardly generally provide surfaces 168, 170 corresponding to the surfaces 156, 158 of the attachment panels 150, 152. Thus, the surfaces 156, 158 of the attachment panels 150, 152 can be adhered to the surfaces 168, 170 of the end portions 162, 164 over substantial surface areas of these surfaces. The adhesives used for such attachment or connection can be sealing adhesives, structural adhesives or both. Preferred adhesives include polyurethane and epoxy adhesives as discussed herein, but can be any of the other adhesives discussed herein or others unless otherwise specifically stated. It is also contemplated that additional attachments such as welds or mechanical fasteners may attach these panels 150, 152 to the portions 162, 164. Further, it will be understood that the added or alternative features of the assembly of FIG. 5 can be easily incorporated into the embodiments of FIGS. 1-4 and vice versa.

Unless stated otherwise, dimensions and geometries of the various structures depicted herein are not intended to be restrictive of the invention, and other dimensions or geometries are possible. Plural structural components can be provided by a single integrated structure. Alternatively, a single integrated structure might be divided into separate plural components. In addition, while a feature of the present invention may have been described in the context of only one of the illustrated embodiments, such feature may be combined with one or more other features of other embodiments, for any given application. It will also be appreciated from the above that the fabrication of the unique structures herein and the operation thereof also constitute methods in accordance with the present invention.

The preferred embodiment of the present invention has been disclosed. A person of ordinary skill in the art would realize however, that certain modifications would come within the teachings of this invention. Therefore, the following claims should be studied to determine the true scope and content of the invention.

What is claimed is:

1. A rear module for an automotive vehicle, comprising:
a first cross-vehicle structure, wherein:
i. the first cross-vehicle structure is a panel formed substantially entirely of plastic material;
a second cross-vehicle structure, wherein:
i. the second cross vehicle structure is formed substantially entirely of a metal material;
ii. the second cross vehicle structure is attached to the first cross vehicle structure with adhesive and less than 10 welds;
wherein the rear module is configured for attachment to a rear portion of the vehicle such that the rear module extends laterally across the rear portion of the vehicle.

2. A module as in claim 1 wherein the second structure is a substantial portion of the vehicle that defines the trunk space of the vehicle.

3. A module as in claim 1 wherein the second cross-vehicle structure is located inside the first vehicle structure relative to the vehicle.

4. A module as in claim 1 further comprising a third cross-vehicle structure attached to the first vehicle structure with adhesive and less than 10 welds.

5. A module as in claim 4 wherein the third structure is configured to extend along an upper edge of the first structure.

6. A module as in claim 4 wherein either the second structure or the third structure or both are attached to the first structure without any welds.

7. A module as in claim 1 wherein the second cross vehicle structure is adhered to the first cross vehicle structure such that a cavity of the first structure, a cavity of the second structure or both is formed into a substantially enclosed tunnel between the first and second structures.

8. A module as in claim 1 wherein the first structure includes a plurality of first openings, the second structure includes a plurality of second openings or both and the first openings, the second openings or both are configured for receiving fasteners that fasten a bumper beam to the vehicle.

9. A module as in claim 1 further comprising:
a first light assembly located within the cavity of the first distal portion or the first structure; and
a second light assembly located within the cavity of the second distal portion or the first structure.

10. A module as in claim 1 wherein the first structure is formed by molding using a process selected from injection molding or compression molding.

11. A module as in claim 1 wherein the first structure the second structure and the third structure each includes one or more corresponding surfaces that are adhesively secured with the adhesive to one or more corresponding surfaces of one or both of the other structures.

12. A module as in claim 1 wherein the plastic material comprises a homopolymer selected from a polyolefin, a polystyrene and a polyamide or a copolymer.

13. A module as in claim 1 wherein the plastic material comprises polypropylene.

14. A module as in claim 1 wherein the first cross-vehicle structure includes portions having attachment surfaces that correspond to attachment surfaces of attachment panels of the vehicle and wherein the attachment panels are located adjacent rear quarter panels of the vehicle and the attachment panels are disposed transverse to the fore/aft direction of the vehicle.

15. A module as in claim 1 wherein the plastic includes a reinforcement material selected from a fiber and a mineral.

16. A rear module for an automotive vehicle, comprising:
a first cross-vehicle structure, wherein:
i. the first cross-vehicle structure is a panel formed substantially entirely of plastic material;
a second cross-vehicle structure, wherein:
i. the second cross vehicle structure is formed substantially entirely of a metal material;
ii. the second cross vehicle structure is attached to the first cross vehicle structure with adhesive and less than 10 welds;
wherein the rear module attaches to a rear portion of the vehicle such that the rear module extends laterally across the rear portion of the vehicle;
wherein the second cross vehicle structure is adhered to the first cross vehicle structure such that a cavity of the first structure, a cavity of the second structure or both is formed into a substantially enclosed tunnel between the first and second structures; and
wherein the first structure and the second structure each includes one or more corresponding surfaces that are adhesively secured with the adhesive to one or more corresponding surfaces of the other of the first and second structure.

17. A module as in claim 16, further comprising a third cross-vehicle structure, wherein:
i. the third cross-vehicle structure is attached to the first vehicle structure with adhesive and less than 10 welds;
ii. the third structure is configured to extend along an upper edge of the first structure; and
iii. the third structure includes one or more corresponding surfaces adhesively secured with adhesive to the one or more corresponding surfaces of the first structure or second structure.

18. A module as in claim 17 wherein the the third structure is separate from the second structure.

19. A module as in claim 16 wherein the first structure and the second structure are a substantial portion of the vehicle that defines the trunk space of the vehicle and wherein wherein the first structure includes a plurality of first openings, the second structure includes a plurality of second openings or both and the first openings, the second openings or both are configured for receiving fasteners that fasten a bumper beam to the vehicle.

20. A rear module for an automotive vehicle, comprising:
a first cross-vehicle structure having a first distal portion opposite a second distal portion and an intermediate portion interconnecting the first and second distal portions, wherein:
i. the the first and second distal portions are configured to be adjacent first and second rear quarter panels upon assembly of the module to the vehicle;
ii. the first and second distal portions extend upwardly relative to the intermediate portion upon assembly of the module to the vehicle;
iii. the first and second distal portions each define a cavity for receiving at least a portion of a rear vehicle light;
iv. the first vehicle structure defines a cavity that extends substantially entirely cross-vehicle along the intermediate portion of the first structure;
v. the first cross-vehicle structure is a panel formed substantially entirely of plastic material; and
vi. a plurality of first openings are defined in the first structure;
a second cross-vehicle structure having a length extending from a first distal end to a second distal end, the first distal end opposite the second distal end, wherein:
i. the second cross vehicle structure is a metal panel;
ii. the second cross vehicle structure defines a cavity extending along substantially the entire length of the second structure;
iii. the second cross vehicle structure has a peripheral edge surface that is adhered to a peripheral edge surface of the first cross vehicle structure such that the cavity of the first structure and the cavity of the second structure cooperatively form a substantially enclosed tunnel between the first and second structures;
iv. the second structure includes a plurality of second openings that align with the plurality of first openings and are cooperatively configure for receiving fasteners that fasten a bumper beam to the vehicle;
v. the second structure is attached to the first structure with less than 5 welds;
a third cross vehicle structure extending from a first distal end to a second distal end, wherein:
i. the third structure is configured to extend along an upper edge of the first structure;
ii. the third structure defines a cavity extending substantially entirely along the third structure from its first distal end to its second distal end;
iii. the third vehicle structure is adhered to the first cross-vehicle structure such that the third structure and first structure enclose the cavity if the third structure thereby forming a tunnel;
iv. the third structure is attached to the first structure with less than 5 welds;
a first light assembly located within the cavity of the first distal portion or the first structure;
a second light assembly located within the cavity of the second distal portion or the first structure.
